(19) United States
(12) Patent Application Publication
(10) Pub. No.: US 2021/0268886 A1
(43) Pub. Date: Sep. 2, 2021

(54) VEHICLE BODY LOWER STRUCTURE

(71) Applicants: TOYOTA JIDOSHA KABUSHIKI KAISHA, Aichi (JP); SUBARU CORPORATION, Tokyo (JP)

(72) Inventors: Takayuki NAKAMURA, Toyota-shi (JP); Masataka OGUSHI, Okazaki-shi (JP); Shinichiro NODA, Toyota-shi (JP); Katsuya OOSHIMA, Shibuya-ku (JP)

(21) Appl. No.: 17/176,180

(22) Filed: Feb. 16, 2021

(30) Foreign Application Priority Data
Mar. 2, 2020 (JP) 2020-035279

(51) Int. Cl. B60K 1/04; B62D 25/20; B60L 50/60

(52) U.S. Cl. CPC B60K 1/04; B62D 25/20; B60Y 2306/01; B60K 2001/0438; B60L 50/66

(57) ABSTRACT

A vehicle body lower structure may include: a battery housing arranged under a floor panel; a protector plate arranged under the battery housing; and a battery stack in which an intermediate plate and a plurality of battery cells are stacked. The battery stack may be housed in the battery housing. A protrusion may be provided on at least one of a bottom plate of the battery housing or the protector plate. The protrusion may protrude toward the other of the bottom plate and the protector plate. The protrusion may be positioned under the intermediate plate.

### CROSS-REFERENCE TO RELATED APPLICATION

This application claims priority to Japanese Patent Application No. 2020-035279 filed on Mar. 2, 2020, the contents of which are hereby incorporated by reference into the present application.

### TECHNICAL FIELD

The technology disclosed herein relates to a vehicle body lower structure. The technology particularly relates to a vehicle body lower structure in which a battery housing is arranged under a floor panel and a protector plate is arranged under the battery housing.

### BACKGROUND

In an electric vehicle, a plurality of battery cells that supplies electric power to a traction motor is arranged under a floor panel of a vehicle body. Japanese Patent Application Publication No. 2018-6117 describes an example of such a structure. The plurality of battery cells is housed in a housing, and the housing is attached under the floor panel.

### SUMMARY

While a vehicle is moving, a bottom of the vehicle body may contact with stones, rocks, bumps or speed breakers on the road, for example. If battery cells are arranged under a floor panel, the battery cells may get damaged by a strong impact applied to the bottom of the vehicle body. The disclosure herein provides a vehicle body lower structure that protects battery cells against an impact applied from below a vehicle body.

A vehicle body lower structure disclosed herein may comprise a battery housing arranged under a floor panel; a protector plate arranged under the battery housing; and a battery stack housed in the battery housing. In the battery stack, an intermediate plate and a plurality of battery cells are stacked. A protrusion may be provided on at least one of a bottom plate of the battery housing or the protector plate. The protrusion may protrude toward the other of the bottom plate and the protector plate. The protrusion may be positioned under the intermediate plate.

When the protector plate contacts with a rock or the like while the vehicle is moving, the impact is applied to the bottom plate of the battery housing through the protrusion. Since the protrusion is positioned under the intermediate plate of the battery stack, the impact applied through the protrusion is not received by the battery cells but by the intermediate plate. The impact applied from below the vehicle body is received by the intermediate plate, thus damage to the battery cells is reduced. The vehicle body lower structure disclosed herein protects the battery cells against the impact applied from below the vehicle body.

The details of and further improvements the technology disclosed herein will be described in “DETAILED DESCRIPTION” below.

### BRIEF DESCRIPTION OF DRAWINGS

Fla 1 is a perspective view of a floor panel of a vehicle body.

FIG. 2 is an exploded view of a battery housing.

FIG. 3 is a plan view of the battery housing.

FIG. 4 is a cross-sectional view of the battery housing and a protector plate.

FIG. 5 is a cross-sectional view of a vehicle body lower structure according to a variant.

### DETAILED DESCRIPTION

With reference to the drawings, a vehicle body lower structure 2 according to an embodiment will be described. The vehicle body lower structure 2 according to the embodiment is adopted in an electric vehicle. FIG. 1 shows a perspective view of a vehicle body 100 of the electric vehicle. A floor of its cabin corresponds to a floor panel 3. The floor panel 3 is also a part of the vehicle body 100. In the coordinate system in FIG. 1, an F-axis indicates a front direction of the vehicle, a V-axis indicates an up direction of the vehicle, and an L-axis indicates “left” when the vehicle is seen from its rear to front. Each axis of the coordinate system means the same in the following drawings as well.

A battery housing 10 is arranged under the floor panel 3. FIG. 1 schematically depicts the battery housing 10. The battery housing 10 houses a plurality of battery cells (not shown). The electric vehicle includes a traction motor (not shown), and the plurality of battery cells supplies electric power thereto.

The floor panel 3 and the battery housing 10 are supported by a pair of rockers 4. The rockers 4 are respectively arranged at lateral lower parts of the vehicle body 100 in a vehicle width direction and extend in a front-rear direction of the vehicle body 100. The pair of rockers 4 is a type of a frame to retain strength of the vehicle body 100. The rockers may be called side sills.

Although invisible in FIG. 1, a protector plate 5 that protects the battery housing 10 is attached to a bottom of the vehicle body 100 (under the battery housing 10). The protector plate 5 is also fixed to the pair of rockers 4. The battery housing 10 is positioned in a space between the protector plate 5 and the floor panel 3.

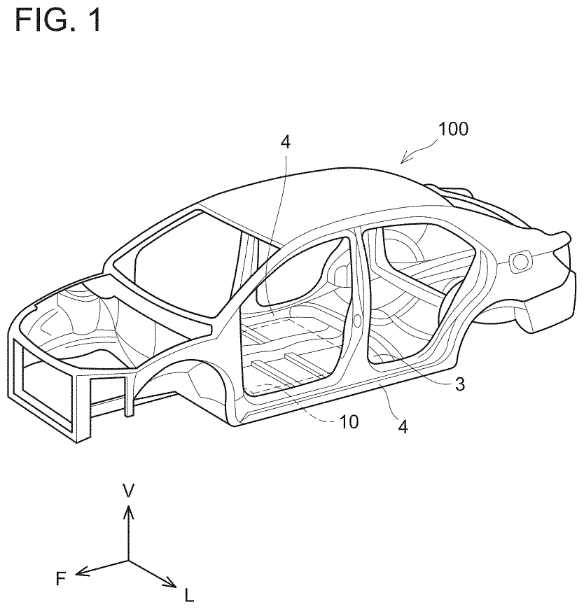

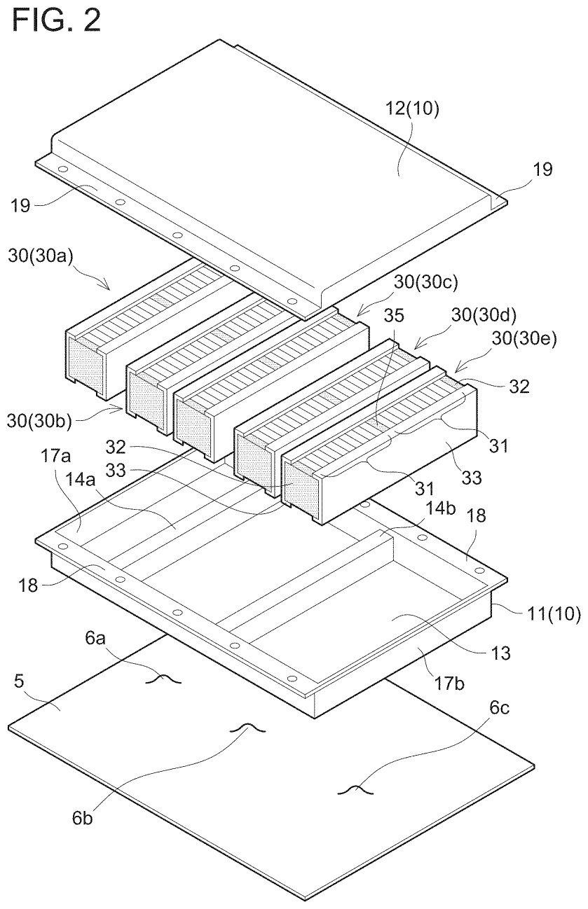

The battery housing 10 will be described. FIG. 2 shows an exploded perspective view of the battery housing 10. FIG. 2 also shows the protector plate 5 positioned under the battery housing 10.

The battery housing 10 is configured of a housing body 11 and a housing cover 12. The housing body 11 and the housing cover 12 respectively include flanges 18 and flanges 19. The flanges 18 are fastened to the flanges 19 with bolts (not shown), as a result of which the housing cover 12 is fixed to the housing body 11.

Crossmembers 14a, 14b extending in the vehicle width direction (the L direction in the drawings) are provided in the housing body 11. The crossmembers 14a, 14b are formed by bending a bottom plate 13 of the housing body 11. The crossmembers 14a, 14b enhance strength of the housing body 11.

The battery housing 10 houses a plurality of battery stacks 30a to 30e. The battery stacks 30a to 30e may be termed battery stacks 30 to describe them without distinction from each other. Each battery stack 30 is art assembly in which a plurality of battery cells 31, end plates 32, and an intermediate plate 35 are stacked. Each assembly is bound by a pair of clamps 33 (explained later). In FIG. 2, reference signs 31, 3:2, 33, and 35 are respectively given only to the battery cells, the end plates, clamps, and the intermediate plate of the battery stack 30e, and these reference signs are not given to the components of the remaining battery stacks 30a to 30d.

The plurality of battery cells 31 is divided into some groups, and the groups are combined into the battery stack 30. In each battery stack 30, the battery cells 31 are electrically connected in series. The battery stacks 30 are electrically connected in parallel. Such electrical connections implement a high-voltage and high-capacity battery.

In each battery stack 30, the battery cells 31 are stacked with the intermediate plate 35 interposed at the center of the battery stack 30 in a stacking direction of the battery cells 31. The end plates 32 are respectively arranged at ends of each assembly of the battery cells 31. For easy understanding, FIG. 2 shows the end plates 32 and the intermediate plates 35 in gray. Each assembly of the battery cells 31, the intermediate plate 35, and the end plates 32 is bound by a pair of clamps 33. Each battery cell 31 has a flattened shape. Each of the clamps 33 is attached to narrower surfaces of the battery cells 31 to clamp the battery cells 31 from above and below.

In each battery stack 30, the intermediate plate 35 divides the battery cells 31 into two groups. The intermediate plate 35 is arranged at approximately the center of the battery stack 30 in the stacking direction of the battery cells 31. In other words, the intermediate plate 35 divides the battery cells 31 included in the battery stack 30 into two groups. Dividing the battery cells 31 into two groups facilitates management of the battery cells 31.

Moreover, the a half of the battery cells 31 in each battery stack 30 is surrounded by the pair of clamps 33, one of the end plates 32, and the intermediate plate 35. The other half of the battery cells 31 is surrounded by the pair of clamps 33, the other of the end plates 32, and the intermediate plate 35. The clamps 33, the end plates 32, and the intermediate plate 35, which surround the battery cells 31, protect the battery cells 31.

The crossmembers 14a, 14b partition an inner space of the housing body 11. One battery stack 30a is housed between the front crossmember 14a and a front plate 17a of the housing body 11. Two battery stacks 30h, 30c are housed between the two crossmembers 14a and 14b. Two battery stacks 30d, 30e are housed between the rear crossmember 14b and a rear plate 17b of the housing body 11. Housing a small number of the battery stacks 30 in the spaces partitioned with the crossmembers 14a. 14b enhances safety of the battery stacks 30 against a collision.

The protector plate 5 is arranged under the battery housing 10. The protector plate 5 is fixed under the pair of rockers 4 (see FIG. 1). The protector plate 5 protects the battery housing 10 against contact with stones kicked up while the vehicle is moving or rocks protruding from the ground.

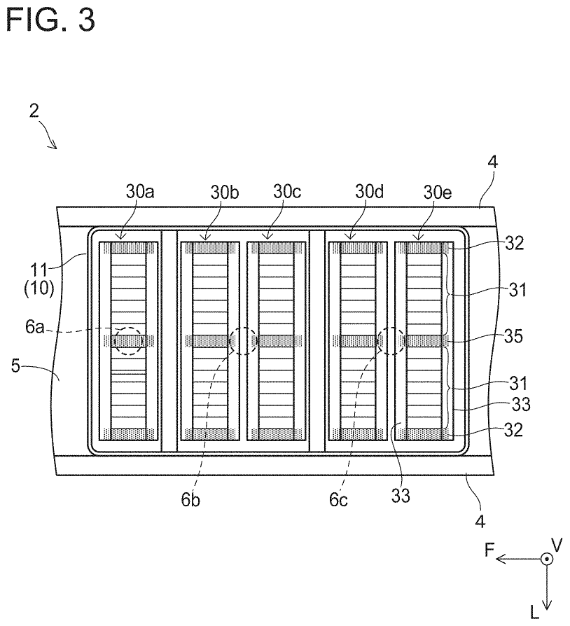

The protector plate 5 is provided with a plurality of upwardly protruding protrusions 6a, 6b, 6c. FIG. 3 shows a plan view of the battery housing 10 and the protector plate 5 attached to the rockers 4. FIG. 3 does not show the housing cover 12 of the battery housing 10 nor the floor panel 3. In FIG. 3, the reference signs 31, 3:2, 33, and 35 are respectively given only to the battery cells, the end plates, the clamps, and the intermediate plate of the battery stack 30e, but these reference signs are not given to the components of the remaining battery stacks 30a to 30d.

FIG. 3 shows positions of the protrusions 6a to 6c by dashed lines. Moreover, FIG. 3 shows the end plates 32 and the intermediate plates 35 in gray. Although parts of the end plates 32 and the intermediate plate 35 are invisible because they are hidden by a corresponding pair of the clamps 33, FIG. 3 shows regions of the end plates 32 and the intermediate plate 35 in gray.

The protrusion 6a is positioned directly under the intermediate plate 35 of the battery stack 30a. The protrusion 6b extends from a position under an end of the intermediate plate 35 of the battery stack 30b to a position under an end of the intermediate plate 35 of the battery stack 30c. The protrusion 6c extends from a position under an end of the intermediate plate 35 of the battery stack 30d to a position under an end of the intermediate plate 35 of the battery stack 30e. Each of the protrusions is positioned under its corresponding intermediate plate(s).

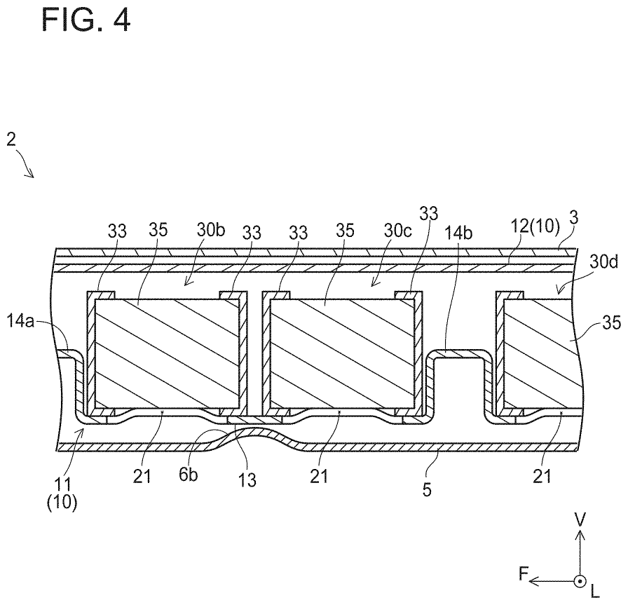

FIG. 4 shows a cross-sectional view of the battery housing 10 and the protector plate 5. FIG. 4 is a cross-sectional view of the battery stacks 30b, 30c and their surroundings. The cross section of FIG. 4 is obtained by cutting the battery housing 10 and the protector plate 5 along a plane traversing the intermediate plates 35. The battery housing 10 is positioned in the space between the floor panel 3 and the protector plate 5.

The bottom plate 13 of the housing body 11 is provided with a channel 21 through which a coolant flows. In FIG. 4, the channel 21 is in contact with bottoms of the intermediate plates 35. The channel 21 extends in the stacking direction of the battery cells 31 of the battery stacks 30 (in the L direction in the coordinate system in the drawing) and is in contact with bottoms of the battery cells 31. The battery cells 31 are cooled by the coolant flowing through the channel 21.

There is a space between the protector plate 5 and the battery housing 10. As described above, the upwardly protruding protrusion 6b is provided on the protector plate 5. The protrusion 6b extends from the position under an end (a lower corner) of the intermediate plate 35 of the battery stack 30b to the position under an end (a lower corner) of the intermediate plate 35 of the battery stack 30c. Similarly, the protrusion 6c extends from the position under an end (a lower corner) of the intermediate plate 35 of the battery stack 30d to the position under an end (a lower corner) of the intermediate plate 35 of the battery stack 30e. As described with reference to FIG. 3, the protrusion 6a is positioned directly under the intermediate plate 35 of the battery stack 30a.

Features of the vehicle body lower structure 2 will be listed below. The protector plate 5 protects the battery housing 10 against contact with stones kicked up while the vehicle is moving and/or rocks on the road. When the protector plate 5 hits a rock on the road, the protector plate 5 is thereby deformed upward. As a result, the protrusions 6a to 6c are brought into contact with the bottom plate 13 of the battery housing 10. Since the protrusions 6a to 6c are positioned under the intermediate plates 35, the intermediate plates 35 receive the impact transmitted through the protrusions 6a to 6c. The impact through the protrusions 6a to 6c is not directly transmitted to the battery cells 31, thus damage to the battery cells 31 is reduced.

Each intermediate plate 35 is positioned at the center of the corresponding battery stack 30 in the stacking direction of the battery cells 31. When the intermediate plate 35 receives an impact from below, the battery stack 30 is thereby deformed such that the center in the stacking direction protrudes upward. In other words, the battery stack 30 is deformed into an arch shape with its center raised higher than its ends. Such deformation also contributes to reduction in impact to the battery cells 31.

The protrusion 6b extends from the position under an end (lower corner) of the intermediate plate 35 of one of the battery stacks 30b, 30c, which are adjacent to each other, to the position under an end (lower corner) of the intermediate plate 35 of the other of the battery stacks 30b, 30c. When the protrusion 6b is moved upward, the impact is transmitted to both of the intermediate plates 35 of the battery stacks 30b, 30c. The impact transmitted through the protrusion 6b is distributed between the two intermediate plates 35. This also contributes to reduction in damage to the battery cells 31.

The protrusion 6a is positioned directly under the intermediate plate 35 of one battery stack 30a. When the bottom of the vehicle body contacts with a rock, the protrusion 6a is moved upward together with the protector plate 5, and the impact is transmitted to one intermediate plate 35. A larger impact is transmitted to the intermediate plate 35 of the battery stack 30a as compared with the case where a protrusion is positioned under two intermediate plates 35. However, the intermediate plate 35 of the battery stack 30a also contributes to reduction in damage to the battery cells 31.

As shown in FIG. 4, the battery housing 10 includes the crossmembers 14a, 14b, and each of the protrusions 6a to 6c is arranged not to overlap with the crossmembers 14a, 14b in the plan view. When an impact is applied to the crossmembers 14a, 14b from below the vehicle body, the battery housing 10 may be deformed. Arranging each of the protrusions 6a to 6c not to overlap with the crossmembers 14a, 14b in the plan view can diminish the deformation of the battery housing 10 due to the impact from below the vehicle body.

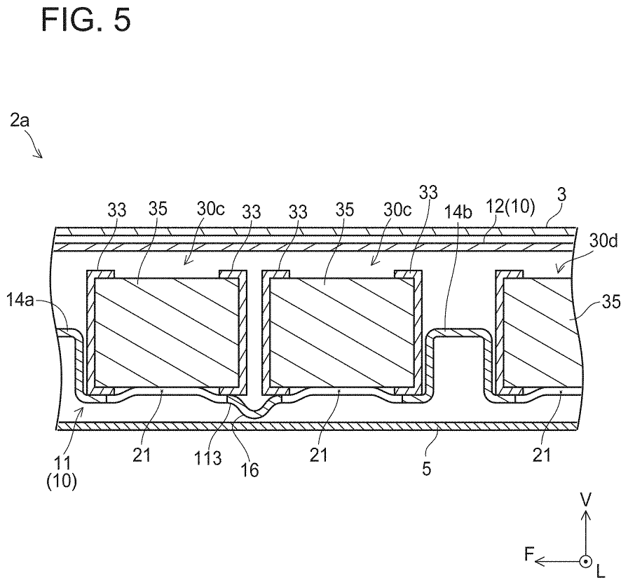

FIG. 5 shows a cross-sectional view of a vehicle body lower structure 2a according to a variant. In the vehicle body lower structure 2a according to the variant, no protrusion is provided on the protector plate 5, but a protrusion 16 is provided on a bottom plate 113 of the battery housing 10. The protrusion 16 protrudes downward toward the protector plate 5. The protrusion 16 is arranged under the intermediate plates 35. The vehicle body lower structure 2a is structurally identical to the above-described vehicle body lower structure 2, except for the protrusion 16. The vehicle body lower structure 2a according to the variant also provides the same advantages as those of the vehicle body lower structure 2 according to the embodiment.

In the vehicle body lower structure disclosed herein, the protrusion may be provided on at least one of the bottom plate of the battery housing or the protector plate. The protrusion may protrude from one of the bottom plate and the protector plate toward the other. Such a protrusion may be positioned under the intermediate plate.

Some points to be noted regarding the technology described in the embodiment will be listed.

The intermediate plate may be arranged at the center of the battery stack in the stacking direction of the plurality of battery cells. When an impact is applied from below the vehicle body, the intermediate plate is moved upward. With the intermediate plate arranged at the center of the battery stack, the battery cells located on both sides of the intermediate plate are equally raised upward, such that the impact is absorbed.

The battery stacks may be arranged in parallel in the battery housing. For each pair of the battery stacks adjacent to each other, the protrusion may extend from the position under an end (lower corner) of the intermediate plate of one of the pair of battery stacks to the position under an end (lower corner) of the intermediate plate of the other of the pair of battery stacks. An impact transmitted through the protrusion is distributed between the two adjacent intermediate plates.

The battery housing may include at least one beam extending between a corresponding pair of the battery stacks adjacent to each other. In the plan view of the battery housing, each protrusion may be arranged not to overlap with the at least one beam. If the at least one beam overlaps with any protrusion, an impact applied from below the vehicle body would be transmitted to the at least one beam through the protrusion. When a strong impact is applied to the at least one beam, the battery housing may be thereby deformed. Arranging each protrusion not to overlap with the at least one beam can diminish the deformation of the battery housing.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A vehicle body lower structure, comprising:
a battery housing arranged under a floor panel;
a protector plate arranged under the battery housing; and
a battery stack in which an intermediate plate and a plurality of battery cells are stacked, the battery stack being housed in the battery housing;
wherein
a protrusion is provided on at least one of a bottom plate of the battery housing or the protector plate, the protrusion protruding toward the other of the bottom plate and the protector plate, and
the protrusion is positioned under the intermediate plate.

2. The vehicle body lower structure of claim 1, wherein the intermediate plate is arranged at a center of the battery stack in a stacking direction of the battery cells.

3. The vehicle body lower structure of claim 1, wherein
the battery stack comprises a plurality of battery stacks,
the battery stacks are arranged in parallel in the battery housing, and
for each pair of the battery stacks adjacent to each other, the protrusion extends from a position under a lower corner of the intermediate plate of one of the pair of battery stacks to a position under a lower corner of the intermediate plate of the other of the pair of battery stacks.

4. The vehicle body lower structure of claim 1, wherein
the battery stack comprises a plurality of battery stacks,
the battery housing comprises at least one beam, each of the at least one beam extending between a corresponding pair of the battery stacks adjacent to each other, and
in a plan view of the battery housing, each protrusion is arranged not to overlap with the at least one beam.

5. The vehicle body lower structure of claim 1, wherein the protector plate is fixed to a pair of rockers.
